(19) United States
(12) Patent Application Publication
(10) Pub. No.: US 2005/0134504 A1
(43) Pub. Date: Jun. 23, 2005

(54) Vehicle appliance having hands-free telephone, global positioning system, and satellite communications modules combined in a common architecture for providing complete telematics functions

(75) Inventors: Jody K. Harwood, Canton, MI (US); Jason G. Bauman, Huntington Woods, MI (US); Kenan Robert Rudnick, Bloomfield Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/745,383

(22) Filed: Dec. 22, 2003

(51) Int. Cl. G01S 1/00

(52) U.S. Cl. 342/357.14

(57) ABSTRACT

A vehicle appliance includes hands-free telephone, global positioning system (GPS), and satellite communications modules combined in a common architecture for providing complete telematics functions to a vehicle operator. The telephone module enables the operator to establish a cell phone call between a cell phone in the vehicle and a phone external to the vehicle using voice commands. The GPS module communicates with GPS satellites to generate data regarding the position of the vehicle and to output a map display of the position of the vehicle for the operator to view. The satellite communications module establishes a satellite call with a service provider via a satellite. The satellite communications module communicates voice commands of the operator received by the hands-free telephone module along with vehicle position data generated by the GPS module to the service provider during the satellite call for such services as navigation, concierge, emergency, and the like.

### BACKGROUND OF THE INVENTION

1. Field of the Invention

The present invention relates generally to hands-free telephone systems and global positioning systems (GPS) for use in a vehicle. More particularly, the present invention relates to a vehicle appliance having hands-free telephone, global positioning system (GPS), and satellite communications modules combined in a common architecture for providing complete telematics functions to an operator of the vehicle.

2. Background Art

A conventional hands-free telephone system for a vehicle such as the Uconnect™ hands-free telephone system enables an operator of the vehicle such as the driver to talk on a cell phone while using both hands for driving the vehicle during a call. Typically, the driver manually uses keys on the cell phone to access functions, other than when answering a phone call, making a phone call, or re-dialing a recently dialed number. Conventional hands-free telephone systems employ a voice recognition module which enables the driver to answer and make phone calls and re-dial numbers using voice commands. As such, the advantages of conventional hands-free telephone systems for vehicles are added convenience and safety.

Certain vehicular, hands-free telephone systems employ Bluetooth™ communications technology. Such systems include a vehicle appliance which is typically configured as part of the operating panel of the vehicle. The vehicle appliance includes a Bluetooth™ communications module for wirelessly communicating with a Bluetooth™ enabled cell phone located somewhere in the vehicle. The vehicle appliance further includes a voice recognition module and other input interfaces such as keypads and buttons for receiving voice commands and other input commands from the driver regarding the use of the cell phone. The vehicle appliance is further connected to the vehicle electrical bus architecture in order to output verbal and display information through the vehicle's radio speakers and display screens.

Conventional global positioning systems (GPS) for vehicles provide information to the driver regarding the position of the vehicle on a map. GPS is based on satellite ranging in which a GPS module within the vehicle communicates with a constellation of satellites to determine the location of the vehicle as the driver is driving the vehicle through a city, the countryside, and the like. Typically, GPS is used with a map display which shows the location of the vehicle and a navigation route on the map display which shows directions on how to reach a desired destination.

The OnStar™ communications system enables the driver to make a cell phone call to communicate with a service provider. The OnStar™ system is set-up such that the vehicle in effect has its own embedded cell phone to call the service provider using cell phone infrastructure. The driver may also use the embedded cell phone to make a cell phone call to an external phone. The built-in cell phone service cannot be removed from the vehicle so the embedded cell phone is mobile only as long as the driver is in the vehicle.

The driver may use the OnStar™ system to call the service provider for such services as obtaining navigation directions to find a desired location while driving, obtaining concierge information to find the nearest gas stations, restaurants, etc., providing requests for emergency assistance and towing services, and the like. In response to being called by the driver, the service provider sets-up a call between a human advisor with the driver. The service provider monitors the position of the vehicle using GPS technology. The human advisor provides the desired information to the driver in conjunction with the information regarding the position of the vehicle.

### SUMMARY OF THE INVENTION

It is an object of the present invention to provide a vehicle appliance having hands-free telephone, global positioning system (GPS), and satellite communications modules combined in a common architecture for providing complete telematics functions to an operator of the vehicle.

In carrying out the above object and other objects, the present invention provides a vehicle appliance having hands-free telephone, global positioning system (GPS), and satellite communications modules. The hands-free telephone module is operable for enabling an operator of the vehicle to establish a cell phone call between a cell phone in the vehicle and a phone external to the vehicle using voice commands. The GPS module is operable for communicating with GPS satellites to generate data regarding the position of the vehicle and to output a map display of the position of the vehicle for the operator to view. The satellite communications module is operable to establish a satellite call with a service provider via a satellite. The satellite communications module is operable to communicate voice commands of the operator received by the hands-free telephone module along with vehicle position data generated by the GPS module to the service provider during the satellite call. The hands-free telephone, GPS, and satellite communications modules are combined in a common architecture.

The voice command of the operator may be indicative of a desired destination. In this case, the satellite communications module transmits to the service provider a voice signal indicative of the desired destination along with the vehicle position data in order to receive from the service provider navigation directions between the positions of the vehicle and the desired destination. Such navigation directions may include traffic data and route data. The GPS module is operable with the satellite communications module to output a map display of the position of the vehicle, the position of the desired destination, and the navigation directions for the operator to view. The hands-free telephone module may include a voice synthesizer operable for translating the navigation directions received by the satellite communications module into vocal communications for output by a vehicle speaker for the operator to hear.

The voice synthesizer is also operable for translating the vehicle position data generated by the GPS module into vocal communications for output by a vehicle speaker for the operator to hear.

In the case of the voice command being indicative of a desired destination, the GPS module is operable with the hands-free telephone module to output a map display of the position of the vehicle and the position of the desired destination for the operator to view irrespective of any navigation directions.

The satellite communications module is operable for transmitting voice communications of the operator received by the hands-free telephone module to the service provider during the satellite call. The hands-free telephone module is operable with the satellite communications module for outputting voice communications received by the satellite communications module from the service provider during the satellite call to speakers of the vehicle for the operator to hear. The service provider is operable with the public switched telephone network (PTSN) for establishing a satellite phone call between the satellite communications module and an external phone connected to the PTSN during the satellite call.

The hands-free telephone module includes a communications module operable for wirelessly communicating with the cell phone in order to transmit to the cell phone the operator's voice communications spoken into a microphone of the vehicle for transmission to the external phone during the cell phone call, and to receive voice communications received by the cell phone from the external phone for transmission to speakers of the vehicle for the operator to hear during the cell phone call. In this case, the cell phone is a Bluetooth™ enabled cell phone and the communications module is a Bluetooth™ enabled communications module.

Further, in carrying out the above object and other objects, the present invention provides an associated telematics system for a vehicle. The telematics system includes a service provider satellite and a global positioning system (GPS) satellite both in orbit. A service provider is in wireless communication with the service provider satellite. The telematics system further includes a vehicle appliance having hands-free telephone, GPS, and satellite communications modules combined in a common architecture. The hands-free telephone module enables an operator to establish a cell phone call between a cell phone in the vehicle and a phone external to the vehicle using voice commands. The GPS module communicates with the GPS satellite to generate data regarding the position of the vehicle and to output a map display of the position of the vehicle for the operator to view. The satellite communications module establishes a satellite call with a service provider via the service provider satellite. The satellite communications module communicates voice commands of the operator received by the hands-free telephone module along with vehicle position data generated by the GPS module to the service provider during the satellite call.

### BRIEF DESCRIPTION OF THE DRAWINGS

FIG. 1 illustrates a block diagram of a vehicle appliance having hands-free telephone, global positioning system (GPS), and satellite communications modules combined in a common architecture for providing complete telematics functions to an operator of the vehicle in accordance with the present invention; and

FIG. 2 illustrates a block diagram of the overall system configuration in which the vehicle appliance is employed in accordance with the present invention.

### DETAILED DESCRIPTION OF THE PREFERRED EMBODIMENT(S)

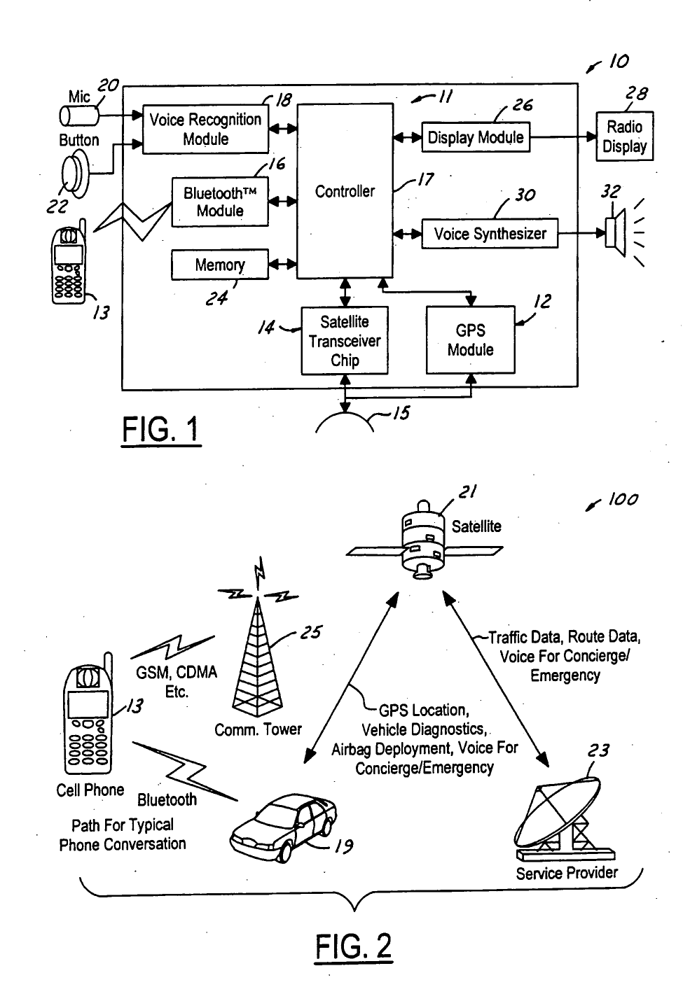

Referring now to FIG. 1, a block diagram of a vehicle appliance 10 having hands-free telephone, global positioning system (GPS), and satellite communications modules combined in a common architecture for providing complete telematics functions to an operator of the vehicle in accordance with the present invention is shown. Referring also to FIG. 2, a block diagram of the configuration of a system 100 in which vehicle appliance 10 is employed in accordance with the present invention is shown.

Vehicle appliance 10 is integrated as part of a vehicle 19 such as a truck, car, boat, tank, etc., and may be integrated as part of handheld items to be carried by an operator. Vehicle appliance 10 generally includes a hands-free telephone module 11, a GPS module 12, and a satellite transceiver chip 14 (i.e., satellite communications module). Hands-free telephone module 11 enables an operator of vehicle 19 such as a driver to use a Bluetooth™ enabled cell phone 13 located somewhere in the vehicle in a hands-free manner. Hands-free telephone module 11 enables the driver to control the operation of cell phone 13 using voice commands. Through the use of Bluetooth™ communications technology, hands-free telephone module 11 and cell phone 13 wirelessly transmit signals between themselves to communicate with one another. Bluetooth™ communications technology is well understood by persons of ordinary skill in the prior art.

GPS module 12 communicates with GPS satellites (such as satellite 21) to obtain information regarding the location of vehicle 19. GPS module 12 includes a map display which shows the location of vehicle 19 on a map for the driver to view. GPS module 12 updates the location of vehicle 19 on the map as the vehicle moves from one point to another while being driven. GPS module 12 communicates with satellite 21 using a satellite antenna 15 connected to vehicle 19.

Satellite communications module 14 enables satellite communications via satellite antenna 15 and satellite 21 with a service provider 23. Satellite communications module 14 enables the driver to make a satellite call to service provider 23 for such services as navigation, concierge, door unlock, airbag notification, emergency dialing, and towing assistance. During the satellite call to service provider 23, the driver may speak with a human advisor of the service provider in order to obtain the desired information.

The driver uses hands-free telephone module 11 to make the satellite call in a hands-free manner. For example, hands-free telephone module 11 advises satellite communications module 14 to make a satellite call for navigation services in response to the driver saying the voice command “navigation.” GPS module 12 is configured to provide the position information to service provider 23 via satellite antenna 15 such that the service provider has access to the position of vehicle 19. The human advisor speaks with the driver over the satellite call in order to answer the driver's questions and provide the desired information to the driver. Service provider 23 may also employ a voice activated menu-driven system in order to provide data indicative of the desired information automatically back to vehicle appliance 10 in response to the driver's voice commands.

Each of modules 11, 12, and 14 along with the interoperability between the modules will now be described in greater detail. Central to each of modules 11, 12, and 14 is a controller 17 which controls the overall operation of the modules.

Hands-free telephone module 11 includes a Bluetooth™ communications module 16 which wirelessly communicates with Bluetooth™ enabled cell phone 13. Hands-free telephone module 11 further includes a voice recognition module 18. Voice recognition module 18 is connected to a microphone 20 for receiving voice communications including voice commands from the driver. Voice recognition module 18 is operable to transfer voice communications from the driver via microphone 20 to controller 17. Voice recognition module 18 is also operable to translate voice commands from the driver into corresponding electrical signals for use by controller 17. For example, voice recognition module 18 is operable to translate the voice command “dial” into a corresponding electrical command signal for use by controller 17. Similarly, voice recognition module 18 is operable to translate numeric characters spoken by the driver into corresponding electrical information signals for use by controller 17. Voice recognition module 18 is also connected to an input button 22 for receiving manual commands from the driver. For example, the driver presses input button 22 when the driver desires to have vehicle appliance 10 go into certain modes such as modes for making a satellite call to service provider 23, making a cell phone call to an external phone using cell phone 13, etc.

Hands-free telephone module 11 further includes a memory 24. Memory 24 stores information which may also be stored in the memory of cell phone 13 such as a listing of names and associated telephone numbers. Hands-free telephone module 11 also includes a display module 26 which is connected to a display of vehicle 19 such as an LCD display 28 of the vehicle's radio via the vehicle electrical bus architecture for displaying information to the driver.

Hands-free telephone module 11 also includes a voice synthesizer 30 which is operable to generate electronic voice signals in response to corresponding electrical signals provided by controller 17 during operation. Voice synthesizer 30 is connected to a speaker 32 mounted in vehicle 19 such as the vehicle's radio speakers via the electrical bus architecture. Voice synthesizer 30 outputs the electronic voice signals to the radio speaker 32 for the driver to hear. For example, such outputted electronic voice signals may be the information “Dialing John” when cell phone 13 is dialing John's telephone number.

An example of the general process employed by hands-free telephone module 11 when the driver wants to make a cell phone call will now be described in order to provide a general description of the operation of the telephone module. In order to initiate the cell phone call, the driver presses input button 22 to advise telephone module 11 that the driver wants to make a call. In response, telephone module 11 mutes the radio to free radio speaker 32 for the cell phone call. The driver then speaks multiple voice commands such as “Dial John” into microphone 20.

Voice recognition module 18 processes these voice commands to determine that the driver wants to make a cell phone call to John. Voice recognition module 18 provides this information to controller 17. Controller 17 accesses memory 24 to find a stored telephone number for “John.” (Controller 17 may also be configured to find a stored telephone number for “John” in the memory of cell phone 13 using Bluetooth™ communications module 16.) Upon locating the stored telephone number for John, controller 17 instructs communications module 16 to wirelessly transmit the digits of John's telephone number to cell phone 13 for the cell phone to dial. Cell phone 13 then dials John's telephone number to make the cell phone call to John.

Assuming that John answers his telephone, a cell phone call is connected between cell phone 13 and John's telephone via a cell phone communications tower 25 using typical cell phone communications. John then says “Hello” into his telephone which is received by cell phone 13 via tower 25. Cell phone 13 wirelessly transfers John's “hello” to communications module 16 using Bluetooth™ communications. Controller 17 then outputs John voice with the word “hello” to radio speaker 32 for the driver to hear. The driver then says “hello John” into microphone 20. Communications module 16 wirelessly transmits the driver's “hello John” to cell phone 13 using Bluetooth™ communications. Cell phone 13 transmits the driver's “hello John” to John's telephone via tower 25 using typical cell phone communications.

This process is repeated to enable the conversation between the driver and John. In this way, the driver is able to communicate over a cell phone call with John in a hands-free manner through the use of telephone module 11 and cell phone 13. As the speaker and microphone of cell phone 13 are not required to make the call when using telephone module 11, the cell phone may be anywhere in vehicle 19 such as in a briefcase, the vehicle trunk, etc.

As described above, GPS module 12 communicates with satellite 21 via satellite antenna 15 to receive information regarding the position of vehicle 19. GPS module 12 generally displays the position information on a map display for the driver to view while driving the vehicle. The position information is typically refined down to the street level. Based on position information, GPS module 12 also provides information regarding the direction and speed at which vehicle 19 is traveling.

GPS module 12 communicates with controller 17 to provide such information to controller 17. In turn, controller 17 provides the position information to voice synthesizer 30 for conversion into voice communications for the driver to hear. For example, based on the position information, voice synthesizer 30 outputs something to the effect of “traveling north on Main Street and approaching State Avenue” for the driver to hear on radio speaker 32. If desired, controller 17 may also provide the voice communications of voice synthesizer 30 to cell phone 13 via communications module 16 for the cell phone to transmit during a cell phone call with an external phone via cell phone tower 25. Controller 17 may also provide the position information from GPS module 12 including the verbal communications of voice synthesizer 30 to satellite communications module 14 for transmission to service provider 23 for navigation services during a satellite call.

Telephone module 11, GPS module 12, and satellite communications module 14 function with controller 17 to provide voice activated navigation services to the driver. In operation, the driver presses input button 22 to start the process for obtaining voice activated navigation. The driver then speaks a destination such as “gas station” into microphone 22 for receipt by voice recognition module 18. Voice recognition module 18 converts the spoken destination into electrical signals for use by controller 17. Controller 17 provides information regarding the desired destination to satellite communications module 14. Satellite communications module 14 then establishes a satellite call with service provider 23 and provides the information regarding the desired destination and the position information obtained by GPS module 12 to the service provider. In response, service provider 23 returns route data regarding the gas stations in the vicinity of the position of vehicle 19 back to controller 17 via satellite communications module 14.

Voice synthesizer 30 then outputs something to the effect of “gas station two miles ahead on Main Street” for the driver to hear on radio speaker 32. GPS module 12 may also display information showing positions of vehicle 19 and the gas station on Main Street for the driver to view.

The voice activated navigation services are also practicable in other likely scenarios. For example, the driver wants to reach a destination but does not know the directions for reaching the desired destination. In this case, the driver speaks the address of the desired destination such as “111 State Avenue” into microphone 20 for receipt by voice recognition module 18 when vehicle appliance 10 is in the voice activated navigation mode. As before, voice recognition module 18 converts the spoken address into electrical signals for use by controller 17. Controller 17 provides the address to satellite communications module 14. Satellite communications module 14 establishes a satellite call with service provider 23 and provides the address and position information regarding vehicle 19 to the service provider. In response, service provider 23 returns route data regarding the directions for reaching the desired destination back to controller 17 via satellite communications module 14.

Voice synthesizer 30 then outputs something to the effect of “at Main Street turn right onto State Avenue” for the driver to hear on radio speaker 32. GPS module 12 displays information showing positions of vehicle 19 and the desired destination on a map display for the driver to view. As the position of vehicle 19 changes, satellite communications module 14 may make another satellite call to service provider 23 (or use the same satellite call) to receive updated route data. For example, after the driver has turned right on State Avenue from Main Street, service provider 23 (while monitoring the position of vehicle 19 using the position information generated by GPS module 14) provides updated route data regarding the directions for reaching the desired destination back to controller 17 via satellite communications module 14. In this case, voice synthesizer 30 may output something to the effect of “111 State Avenue is located one block on your left after Main Street” for the driver to hear on radio speaker 32. Again, GPS module 12 displays information showing the updated position of vehicle 19 relative to the desired destination on a map display for the driver to view. Controller 17 may provide the driving directions to memory 24 for future use.

In addition to providing route data, service provider 23 may also provide traffic data to the driver during a satellite call. For example, upon receiving a request for route data to a desired address such as “111 State Avenue” and receiving the information regarding the current position of vehicle 19, service provider 23 may determine whether there are any traffic problems along the appropriate route between the vehicle and the location of the desired address. For example, there may be a traffic accident at the intersection of Main Street and State Avenue. Consequently, advising the driver to make a right turn on State Avenue from Main Street is bad advice. Accordingly, service provider 23 may determine alternate route data and provide this information along with the traffic data to satellite communications module 14 for the driver. In this case, voice synthesizer 30 outputs something to the effect of “accident at the intersection of Main Street and State Avenue” for the driver to hear on radio speaker 32. Voice synthesizer 30 then outputs the alternate route data for the driver to hear and GPS module 12 displays the information regarding the positions of vehicle 19 and the 111 State Avenue address for the driver to view.

In addition to voice activated navigation services, satellite communications module 14 also enables the driver to make a satellite call over satellite 21 to speak with a human advisor of service provider 23. For example, the driver may contact service provider 23 for concierge services such as making restaurant, movie, and hotel reservations, etc. The driver may also make a satellite call to speak to a human advisor of service provider 23 to request relief in case of an emergency. For example, vehicle 19 may become disabled on the highway and the driver may contact service provider 23 to send assistance such as towing. Satellite communications module 14 automatically makes a satellite call to service provider 23 in case of air bag deployment to advise the service provider that vehicle 19 has been involved in a crash and emergency assistance is needed. Service provider 23 may also communicate with satellite communications module 14 to unlock the vehicle doors in case the driver is accidentally locked out of vehicle 19.

Again, the driver may initiate any of these satellite call requests by using voice commands received by hands-free telephone module 11. Hands-free telephone module 11 provides the driver's voice communications spoken into microphone 20 to satellite communications module 14 for transmission to the human advisor of service provider 23 during a satellite call. In turn, hands-free telephone module 11 outputs the human advisor's voice communications received by satellite communications module 14 from service provider 23 on radio speakers 32 for the driver to hear during the satellite call.

In addition to enabling a satellite call for communicating voice and data signals between the driver and service provider 23, telephone module 11, satellite communications module 14, and service provider 23 also function to enable a satellite phone call for communicating voice and data signals between the driver and a phone external to the vehicle. That is, the driver may make a phone call to an external phone such as another person's phone during the satellite call. This option is useful if cell phone 13 is inoperable for some reason such as the cell phone service provider not being able to provide cell phone services in certain areas. For example, the coverage area of the cell phone service provider covers only urban areas and not rural areas. As another example, cell phone 13 may simply not work as a result of being broken or lost and the driver cannot make a cell phone call to the external phone.

In any case, the driver may make a satellite phone call to the external phone using hands-free telephone module 11 and satellite communications module 14. To enable such function, service provider 23 is connected to the public switched telephone network (PTSN). In response to the driver making a request to make a satellite phone call to an external phone satellite communications module 14 makes a satellite call to service provider 23 for the request. Service provider 23 transfers the satellite call to the PTSN. In turn, the PTSN connects the satellite call to the external phone. As such, a satellite phone call is established between the driver, satellite communications module 14, satellite 21, the PTSN, and the external phone. During this satellite phone call, telephone module 11 provides the driver's voice communications spoken into microphone 20 to satellite communications module 14 for transmission to the external phone and outputs the voice communications received from the external phone on radio speakers 32 for the driver to hear during the satellite phone call. As such, the satellite phone call can be conducted by the driver in a hands-free manner using telephone module 11.

Such a satellite phone call may also be initiated by a person using an external phone to the driver. In such case, the external phone makes a request to the PTSN to make a call to cell phone 13 of the driver. The PTSN attempts to establish a cell phone call to cell phone 13 through the cell phone service provider's network, but the cell phone call cannot be made if the cell phone is inoperable. However, a satellite phone call can be made to the driver from the PTSN using satellite communications module 14 and satellite 21. In such case, the PTSN transfers the phone call request from the external phone to service provider 23 which in turn establishes the satellite phone call between the driver and the external phone via the PTSN, satellite 21, and satellite communication module 14.

The cell phone service provider of the driver's cell phone 13 and service provider 23 may partner together in order to have the satellite phone call billed to the service minutes of cell phone 13. Further, a satellite phone call may be conducted between the driver and an external phone directly through satellite 21 without the use of the PTSN. Satellite 21 is able to provide such direct satellite phone call connections between the driver and the external phone as the satellite provides two-way voice link functionality.

Thus, it is apparent that there has been provided, in accordance with the present invention, a vehicle appliance having hands-free telephone, global positioning system (GPS), and satellite communications modules combined in a common architecture for providing complete telematics functions to an operator of the vehicle that fully satisfies the objects, aims, and advantages set forth above. While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

1. A vehicle appliance comprising:
a hands-free telephone module operable for enabling an operator of the vehicle to establish a cell phone call between a Bluetooth® enabled cell phone in the vehicle and a phone external to the vehicle using voice commands, the hands-free telephone module having a voice recognition module for receiving and recognizing voice commands of the operator, wherein the hands-free telephone module further includes a Bluetooth® enabled communications module operable for wirelessly communicating with the cell phone in order to transmit to the cell phone the operator's voice communications spoken into a microphone of the vehicle for transmission to the external phone during the cell phone call, and to receive voice communications received by the cell phone from the external phone for transmission to speakers of the vehicle for the operator to hear during the cell phone call;
a global positioning system (GPS) module operable for communicating with GPS satellites to generate data regarding the position of the vehicle and to output a map display of the position of the vehicle for the operator to view; and
a satellite communications module operable to establish a satellite call with a service provider via a satellite, the satellite communications module being operable to communicate voice commands of the operator received by the hands-free telephone module along with vehicle position data generated by the GPS module to the service provider during the satellite call;
wherein in response to the voice recognition module of the hands-free telephone module receiving and recognizing a voice command of the operator indicative of a desired destination, the satellite communications module establishes a satellite call with the service provider via a satellite and then transmits to the service provider during the satellite call a signal indicative of the desired destination along with the vehicle position data in order to receive from the service provider during the satellite call navigation directions between the positions of the vehicle and the desired destination;
wherein the GPS module is operable with the satellite communications module to output a map display of the position of the vehicle, the position of the desired destination, and the navigation directions for the operator to view;
wherein the hands-free telephone module further includes a voice synthesizer operable for translating the navigation directions received by the satellite communications module into vocal communications for output by speakers of the vehicle for the operator to hear.

2-5. (canceled)

6. The system of claim 1 wherein:
the hands-free telephone module includes a voice synthesizer operable for translating the vehicle position data generated by the GPS module into vocal communications for output by a vehicle speaker for the operator to hear.

7. The system of claim 1 wherein:
the navigation directions include traffic data, wherein the GPS module is operable with the satellite communications module to output a map display of the position of the vehicle, the position of the desired destination, the navigation directions, and the traffic data for the operator to view.

8. The system of claim 7 wherein:
the hands-free telephone module includes a voice synthesizer operable for translating the navigation directions including the traffic data received by the satellite communications module into vocal communications for output by a vehicle speaker for the operator to hear.

9. The system of claim 1 wherein:
the navigation directions include traffic data, wherein the hands-free telephone module includes a voice synthesizer operable for translating the navigation directions including the traffic data received by the satellite communications module into vocal communications for output by a vehicle speaker for the operator to hear.

10. (canceled)

11. A vehicle appliance comprising:
a hands-free telephone module operable for enabling an operator of the vehicle to establish a cell phone call between a Bluetooth® enabled cell phone in the vehicle and a phone external to the vehicle using voice commands, the hands-free telephone module having a voice recognition module for receiving and recognizing voice commands of the operator, wherein the hands-free telephone module further includes a Bluetooth® enabled communications module operable for wirelessly communicating with the cell phone in order to transmit to the cell phone the operator's voice communications spoken into a microphone of the vehicle for transmission to the external phone during the cell phone call, and to receive voice communications received by the cell phone from the external phone for transmission to speakers of the vehicle for the operator to hear during the cell phone call;
a global positioning system (GPS) module operable for communicating with GPS satellites to generate data regarding the position of the vehicle and to output a map display of the position of the vehicle for the operator to view; and
a satellite communications module operable to establish a satellite call with a service provider via a satellite, the satellite communications module being operable to communicate voice commands of the operator received by the hands-free telephone module along with vehicle position data generated by the GPS module to the service provider during the satellite call;
wherein in response to the voice recognition module of the hands-free telephone module receiving and recognizing a voice command of the operator indicative of a desired destination, the satellite communications module establishes a satellite call with the service provider via a satellite and then transmits to the service provider during the satellite call a signal indicative of the desired destination along with the vehicle position data in order to receive from the service provider during the satellite call navigation directions between the positions of the vehicle and the desired destination;
wherein the GPS module is operable with the satellite communications module to output a map display of the position of the vehicle, the position of the desired destination, and the navigation directions for the operator to view;
wherein the hands-free telephone module further includes a voice synthesizer operable for translating the navigation directions received by the satellite communications module into vocal communications for output by speakers of the vehicle for the operator to hear;
wherein the satellite communications module is operable for transmitting voice communications of the operator received by the hands-free telephone module to the service provider during the satellite call;
wherein the hands-free telephone module is operable with the satellite communications module for outputting vocal communications received by the satellite communications module from the service provider during the satellite call to speakers of the vehicle for the operator to hear;
wherein the service provider is operable with a public switched telephone network (PSTN) for establishing a satellite phone call between the satellite communications module and an external phone connected to the PSTN during the satellite call, wherein the hands-free telephone module is operable with the satellite communications module for outputting voice communications received by the satellite communications module from the external phone connected to the PSTN during the satellite call to speakers of the vehicle for the operator to hear.

12-13. (canceled)

14. The system of claim 1 wherein:
the hands-free telephone module, the GPS module, and the satellite communications module are combined in a common architecture.

15-20. (canceled)
